(19) United States
(12) Patent Application Publication
(10) Pub. No.: US 2025/0111574 A1
(43) Pub. Date: Apr. 3, 2025

(54) DISPLAY-BASED REVIEW OF IMAGE DATA

(71) Applicant: Analogic Corporation, Peabody, MA (US)

(72) Inventors: Sevag Minas Zoboyan, Wakefield, MA (US); Khai Bui, North Andover, MA (US); Steven Urchuk, Melrose, MA (US); David Brisbois, Danvers, MA (US)

(21) Appl. No.: 18/477,749

(22) Filed: Sep. 29, 2023

(51) Int. Cl. G06T 15/00; G06F 3/04845; G06F 3/14; G06T 3/40

(52) U.S. Cl. CPC G06T 15/00; G06F 3/04845; G06F 3/14; G06T 3/4053

(57) ABSTRACT

One or more examples relate to display-based review of image data. A method includes: setting an image renderer at least partially based on a display configuration for a display system; generating, via the set image renderer, 2D image data of a 2D image representing an item at least partially based on 3D image data of a 3D image representing the item, wherein the 3D image data of the 3D image representing the item is X-ray image data; and streaming, via a network connection, the 2D image data to the display system.

### BACKGROUND

Modern X-ray based aviation threat detection systems generate large 3-dimensional (3D) volumetric image files that are over 400 Megabytes (MB) in size using Computed Tomography (CT) technology. In checkpoint, hold baggage and air cargo applications, it is necessary to transmit and review these image files on remote workstations in a few seconds. Conventional system designs utilize dedicated Gbit or faster network connections for image transmission and high-performance Graphical Processing Units (GPUs) for image display.

Security operations are increasingly requiring the ability to perform image review remotely or regionally, on hardwired and wireless devices, on mobile phones, tablets, laptops, and workstations, and in multiple applications including web browsers. Achieving these goals with conventional networks is a challenge because the required bandwidth and latency cannot be guaranteed, and the graphics processing capability of many devices and applications is insufficient.

Traditionally, image rendering is performed by a powerful (in terms of computer hardware) workstation which receives 3D image data files to be rendered for operator review. The inventors this disclosure appreciate that the transfer of such large data files and the number of files to be transferred introduces significant networking costs and time delays. It also does not allow for scalability and the network and computer hardware must be designed to support the worst-case operational state.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting a system for display-based review of image data produced by an X-ray screening system in accordance with one or more examples.

FIG. 2 is a functional block diagram depicting a process for display-based review of images, in accordance with one or more examples.

FIG. 3 is a block diagram of an image renderer in accordance with one or more examples.

FIG. 4 is a block diagram depicting a system for rendering images for display-based review, in accordance with one or more examples.

FIG. 5 is a block diagram depicting a system to manage display-based review of images, in accordance with one or more examples.

FIG. 6 is a flow diagram depicting a process for display-based review of image data, in accordance with one or more examples.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

An “image” is a static visual representation of a scene or object. An image may be stored as digital or analog information referred to as “image data.” Images discussed herein may be two-dimensional (2D) images or three-dimensional (3D) images.

A “video” is a sequence of images that, when displayed in rapid succession, create the illusion of motion for a moving visual representation of a scene or object. Respective images of a video are typically referred to as a “frame.” A video may be stored as digital or analog information referred to as “video data.” Respective frames of a video discussed herein may be a 2D frame or 3D frame.

3D images and frames discussed herein are obtained via an X-ray scanner, such as a CT scanner, without limitation.

CT-based threat detection systems are widely used to detect threats in cabin (personal) baggage, checked baggage, and air cargo applications. These systems convert tens of thousands X-ray projection measurements into 3D volumetric measurements of CT density, effective atomic number or energy weighted CT density. State-of-the-art systems produce images with 100 to 900 million images voxels per scan, which utilize 0.2 to 1.8 gigabytes (GB) of data storage space (e.g., memory, hard drive, cloud storage, without limitation). Even with near lossless data compression, which can typically reduce image storage requirements by a factor of three to ten, the real time distribution of these image files to display workstations requires multiple, dedicated, high bandwidth (1 or more Gbit/sec) network connections.

Display workstations suitable for displaying large image files typically require a premium Graphics Processing Unit (GPU) and processing units, and a desktop operating system and display application to achieve adequate display performance. Wireless mobile devices such as phones, tablets, and wired or wireless thin client computers are typically not suitable. In addition, browser-based display applications typically lack the resources to render 3D image files. The ability to display images on a range of devices, operating systems and applications is desirable for reduced cost, ease of management, and improved cybersecurity.

According to one or more examples, a data source produces 3D image data. An Automatic threat detection system analyzes the data sets and produces a 3D mask or label that defines regions of the image that may contain threats. The data source transfers the data that represents the 3D image and label data (collectively the “image data”) to an image memory accessible to a rendering process in one block transfer (e.g., a single block transfer, without limitation) or by streaming one or more image slices as they become available (e.g., as they are produced by an X-ray screening system or, without limitation). In one or more examples, the data source transfers the image slices dynamically as they become available. In one or more examples, streaming image slices dynamically as they become available is in contrast to waiting for entire sets of image slices or an entire image to be complete and upon completion streaming the image slices. In one or more examples, streaming image slices dynamically as they become available includes streaming respective image slices without waiting for subsequent slices or requiring pre-determined interval. Such waiting might, as a non-limiting example, incur delay, including delay that is unacceptable or undesirable in time critical applications.

The data source and image memory may be within the same computer or can be separated by a network connection (hard wired, wireless, without limitation). In practice, one or may data sources may transfer image data to one or more rendering process.

An example rendering process takes 3D image data from the image memory and transforms it into a 2D gray scale or 2D color representation using one or more volume rendering algorithms. These 2D images may be two or three orders of magnitude smaller that the 3D image data, which reduces the peak bandwidth required to transfer them by a commensurate amount.

In one or more examples, the default 2D representation of the object may be configured by a set of parameters including the orientation of the 3D image with respect to the 2D volume, the type of visualization algorithm (e.g., surface rendering, semi-transparent projection, maximum intensity projection, cut plane, etc.), the performance characteristics of the display system and its connection, and operational requirements.

In one or more examples, the 2D images are transferred to the display system, which may be on the same computer, but is typically connected via a network. Image files are updated at a rate determined by changes in the display requested by the operator. For example, if an operator requests a new image orientation be presented, the system attempts to transfer images at a rate proportional to the operator's request or some subset of those requests. Image compression within an image and between images may be used to reduce the image bandwidth transferred (e.g., using a JPEG encoding algorithms, MPEG encoding algorithms, without limitation). The quality of the image transferred (e.g., an image metric such as resolution, range of pixel values, a combination thereof, without limitation) may also be reduced in situations where the network connection is temporarily unable to sustain a specific transfer rate or data rate.

In one or more examples, the display system includes an application capable of receiving 2D image data and a graphical user interface. The application may be an executable or implemented in a browser. Communication between the devices may be performed using an Application Programming Interfaces (APIs) implemented using REST or gRPC and a data interchange format such as JSON or Protobuf. Additionally or alternatively, designs may use an application programmed in C++, JAVA or Python.

In one or more examples, the display system is assumed to have default display setting, controls, and user inputs such as a mouse, keyboard, and/or touchscreen that allow the display configuration to be altered dynamically. By interacting with the display, the operator selects the desired display configuration. This may include altering attribute orientation of the 2D image, magnification, image contrast and level, or the visualization algorithm employed.

In one or more examples, the management Agent monitors the data source, rendering process and the display and manages the overall process. For example, it may add additional compute or network resources in cases where the display demand outstrips the capacity of the current resources. It may also act to reduce 2D image updates rates in situations where the network bandwidth or latency is unable to maintain a requested number of images.

In one or more examples, a rendering process is located close to the screening system and connected by high-speed interface within a computer or between computers. The process may be in an on-premises data center or a remote/cloud data center with sufficient network bandwidth and latency.

A non-limiting example of an advantage of the design is that the image display function can be easily separated from the User Interface. Customer use cases that require common workstation user interfaces can be more easily met by separating the relatively straight forward graphical user interface from the image rendering function, which requires domain knowledge to implement.

As a non-limiting example, various examples discussed herein address limitations of existing solutions, enabling the use of low bandwidth networks, multiple devices including mobile and thin clients, client applications and browsers, and in cloud computing. Costs are decreased and the performance of image review workstation maintained over a broad range of devices and connections.

Various examples discussed herein are equally applicable to checkpoint CT, hold baggage and air cargo applications.

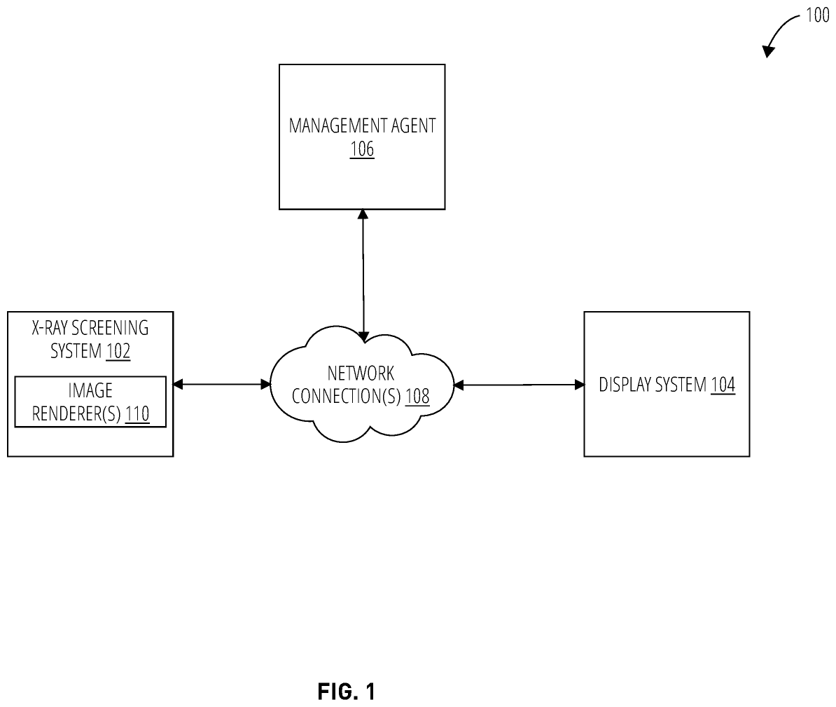

FIG. 1 is a block diagram depicting a system 100 for display-based review of image data produced by an X-ray screening system in accordance with one or more examples.

System 100 includes an X-ray screening system 102, a display system 104, a management agent 106, and network connection(s) 108. X-ray screening systems 102, display system 104 and management agent 106 are in electronic communication with each other via network connection(s) 108.

X-ray screening system 102 generates (e.g., via CT techniques, without limitation) 3D images of items, generates 2D images at least partially based on the 3D images, and provides the 2D images to various systems and devices connected to X-ray screening system 102 via network connection(s) 108, such as display system 104.

Items for which 3D images and 2D images are generated in accordance with one or more examples may vary based on specific operating conditions and operating environment. Thus, this disclosure is not limited to a specific set of items other than the items or portions thereof are sized and shaped to fit within the examination region of an X-ray scanner. In one or more examples, X-ray screening system 102 may be, or be part of, a threat detection system (e.g., an aviation or site threat detection system, without limitation) that processes and displays 3D images generated by X-ray scanners for fast on-, or off-, screen threat resolution. Non-limiting examples of items in a threat detection system for aviation security include baggage (e.g., checked, carry-on, accessible personal property, without limitation), or cargo (e.g., parcels, crates, without limitation), without limitation.

X-ray screening system 102 includes one or more image renderers 110 to generate 2D images at least partially based on 3D images generated by X-ray screening system 102 as discussed below. In one or more examples, respective image renderers 110 may be software executed via one or more virtual machines. A virtualization platform executing on the same or different hardware computing platform as a data source for 3D images (e.g., a 3d image generator, a 3D image storage, without limitation) may abstract the physical hardware resources (e.g., processing cores, system memory (e.g., read-only-memory (ROM), random-access-memory (RAM), cache, page, graphics, without limitation), storage (e.g., hard disc, solid-state, without limitation), input/output (I/O) devices, communication equipment and ports, without limitation) of the hardware computing platform and assign the abstracted hardware resources to one or more virtual machines. Such a virtualization platform may abstract physical processing cores as virtual processes or central processing units (CPUs) as virtual CPUs and assign them to different virtual machines respectively executing one or more image renderers 110. The physical hardware resources available to such a virtualization platform may be added or removed, and abstracted hardware resources may be added or removed from a virtual machine.

When rendering 2D images from 3D images, keeping the renderer close to a data source (e.g., close physical proximity, having therebetween a high data rate connection, a high transfer rate connection, a high bandwidth connection or combinations or subcombinations thereof, without limitation) enables a thin client (a lightweight application that depends on remote computing resources to perform some or a totality of computational tasks) at display system 104 that can operate on a variety of platforms (e.g., a software application executing on a personal computer, tablet computer, workstation, smart phone, without limitation).

Further, rendering 2D images close to a data source reduces operational processing time and costs by reducing the size of and number of large file transfers via network connection(s) 108, because 2D images are smaller than 3D images and high levels of compression can be used that utilize the similarity of adjacent 2d image frames. Further, in cases where 3D image data generated by the X-ray screening system 102 is utilized as the data source (as an alternative to, or in addition to, a separate repository to which the X-ray screening system 102 sends of 3D image data), then the original 3D image data nay be utilized to stream 2D images or 3D images, as the case may be, and using the original 3D image data reduces the chance of communication delays and may reduce the total amount of image data transferred via network connection(s) 108.

Network connection(s) 108 may be or include any combination of wired or wireless network connections for analog or digital electronic communication. Network connection(s) 108 may include or support connections for direct data transfer, private communication networks, and shared communication networks. Any suitable physical connections may be utilized with network connection(s) 108 depending on specific operation conditions, such as Ethernet cable, twisted pair, coaxial, CAN bus, and transmitters and receivers for radiofrequency (RF), Li-Fi, visible light communication (VLC), without limitation.

Display system 104 receives and displays 2D images that are at least partially based on 3D images produced by X-ray screening system 102. Further, display system 104 enables a user (e.g., an operator, without limitation) to interact with, and optionally manipulate, the 2D images as discussed herein. In one or more examples, display system 104 includes a display (e.g., a computer monitor or a screen, without limitation) a computing platform (e.g., including computer hardware such as at least one processor, at least one memory, equipment to communicate via network connection(s) 108, and interfaces for user input such as a mouse, keyboard, or touchscreen, without limitation).

In one or more examples, display system 104 may utilize display settings and controls to set a display configuration that affect one or more of viewing 2D images or interacting with 2D images at display system 104. Respective display configurations may be set by setting values of display settings and control parameters. A display configuration may be set in real-time or set via selection of a default display configuration. In one or more examples, display system 104 may utilize one or more default display configurations defined by predetermined values for display settings, control parameters, or both.

A respective display configuration may affect attribute orientation of a 2D image, or the visualization algorithm employed to generate a 2D image, as discussed below. Settings include display mode (e.g., threat only, surface, laptop removal, unpacked, or slab, without limitation), image orientation, magnification, window and level, opacity, colormap type (e.g., material type, grayscale, low density, inverted), and threat colorization. Controls are provided to allow interactive user functions such cycling through a list of threats, annotating images, and making image measurements such as size and CT number. Management agent 106 monitors X-ray screening system 102 and display system 104 and manages aspects of the display-based review of image data. In one or more examples, management agent 106 monitors a display configuration set at display system 104 and determines one or more of attribute orientation of a 2D image or visualization algorithm employed to generate 2D images. In one or more examples, management agent 106 monitors display demand, network demand, or both and adds or subtracts compute or network resources at least partially based on such demand. In one or more examples, management agent 106 monitors compute capacity (e.g., processing capacity, memory capacity, without limitation), network capacity (e.g., network latency, network bandwidth, network throughput, without limitation), or both and sets image update rates (which may include increasing or decreasing update rates based on a previous setting) at least partially based on such capacity.

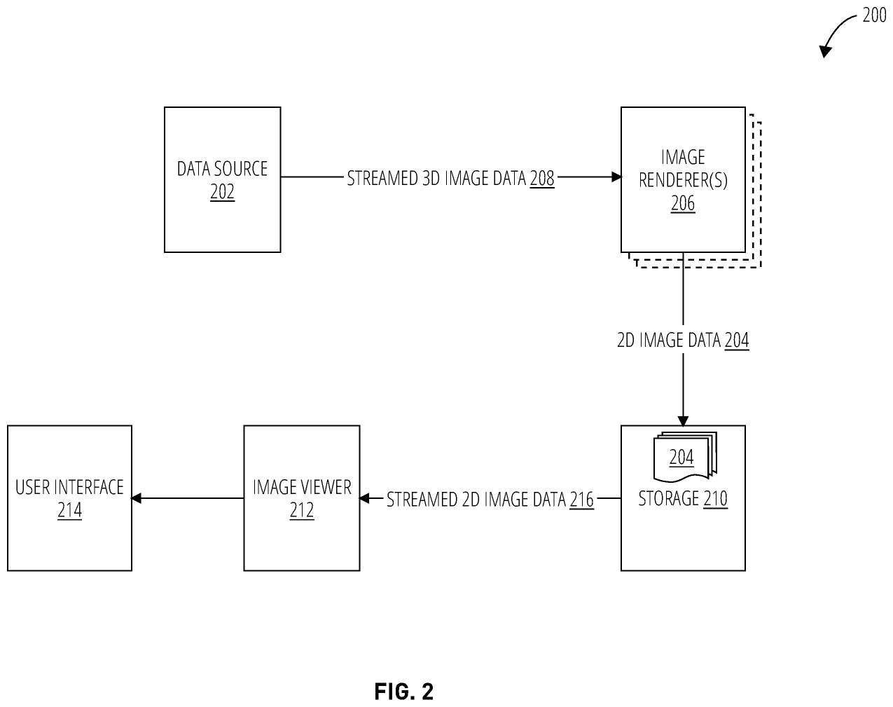

FIG. 2 is a functional block diagram depicting a system 200 for display-based review of images, in accordance with one or more examples.

Functional blocks of system 200 include data source 202, image renderer(s) 206, storage 210, image viewer 212, and user interface 214.

Data source 202 provides 3D images of items generated via X-ray scanners. In one or more examples, data source 202 may be or include an X-ray scanner that generates 3D images utilizing CT techniques, a data management system (DMS) of an X-ray scanner that generates 3D images utilizing CT techniques, a storage device or system that stores 3D images of items generated via X-ray scanners, or a combination or subcombination thereof, without limitation.

The 3D images of items may be image slices, volumetric data, or both. 3D image data (also referred to as “volumetric data”) is a collection of volume pixels (respectively a “voxel”), and a volumetric data set is a collection of voxels that represent a 3D item or specific region of space. Respective voxels in a volumetric data set include information about the item or region of space at a specific location in 3D space. Thus, voxels include depth information. This is in contrast to 2D image data set, which is a collection of pixels arranged in a 2D array and contains information about an object or area at a specific location in 2D space. Both 2D image data and 3D image data may both include information about color, intensity, or other properties.

Image slices are 2D images that are obtained by slicing a 3D volume at a particular depth or position, typically parallel to a particular plane (e.g., axial, sagittal, coronal, or oblique, without limitation). Respective image slices represent respective thin cross-sections of the 3D volume, which respective cross-sections may or may not overlap. A CT scanner generates image slices of a 3D volume that includes an item or region in space via X-ray projection measurements and converts the image slices to 3D volumetric image measurements (e.g., via a process such as computational image reconstruction, without limitation).

3D images may be streamed from data source 202 to one or more image renderer(s) 206 at system 200. Streaming includes transferring 3D images in real time or near-real time. Streamed 3D image data 208 may be processed at image renderer(s) 206 as it arrives, and image renderer(s) 206 do not have to wait for a complete file or volumetric data set to be received. In the case where data source 202 is an X-ray scanner, as the device scans and generates 3D images, these images (full images or slices) may be sent to image renderer(s) 206.

Streaming allows for real-time or near-real-time viewing of the 3D images. Further, by streaming the 3D images, the 3D images may be sent to multiple destinations simultaneously. For instance, it can be displayed in real-time for immediate viewing, while also being stored for further processing or analysis at that time or a later time.

Any suitable networking technology or protocol may be utilized such as TCP (Transmission Control Protocol) or UDP (User Datagram Protocol), depending on the specific needs and constraints of the scenario (for example, whether lossless data transmission is required). The data could be sent over a private network, public network, or combination thereof.

Image renderer(s) 206 generates one or more 2D images from streamed 3D image data 208. More specifically, image renderer(s) 206 processes streamed 3D image data 208 and generates 2D image data 204 at least partially based thereon. In the specific non-limiting example depicted by FIG. 2 image renderer(s) 206 execute in virtual machines running on the same hardware computing platform that includes data source 202. As mentioned above, it is specifically contemplated that image renderer(s) discussed herein such as image renderer(s) 206, without limitation, may execute on a computer, a computer server, a cloud computing environment, or combination or sub-combination thereof.

In one or more examples, image renderer(s) 206 creates a 2D image from a 3D scene using ray tracing, a volume rendering technique commonly used in scientific visualization and computer graphics. Views of the object at one or more different orientations may be derived by changing the orientation of the 2D image and lighting sources. A display system allowed the 2D image to be displayed on a computer screen or other output device.

In various examples, image renderer(s) 206 may determine information about position, orientation, and properties of respective objects in a 3D scene, and about position and properties of light sources and perspective (e.g., camera view, without limitation); determines intensity and color of light that each pixel would receiver based on the physical properties of the materials in the scene and the position and orientation of the objects and lights; and converts this information into a 2D image that can be displayed on a computer screen or other output device.

In one or more examples, the set of rules and procedures utilized by image renderer(s) 206 to generate a visual representation of a 3D scene or 2D scene and convert between the two may be defined in one or more visualization algorithms, as discussed below.

Generally speaking, 2D image data 204 is two to three orders of magnitude smaller than streamed 3D image data 208. Thus, the peak bandwidth utilized to transfer 2D image data 204 via a network connection (e.g., network connection(s) 108) is proportionally smaller than the peak bandwidth that would otherwise be utilized to transfer streamed 3D image data 208.

Storage 210 stores the 2D image data 204 (e.g., arrays of pixels, without limitation) generated by image renderer(s) 206. Storage 210 and the 2D image data 204 stored thereon is accessible, directly or indirectly, by image viewer 212. In one or more examples, storage 210 may be in a storage device at X-ray screening system 102, display system 104, in a networked storage device, in a cloud-based storage device, or a combination or sub-combination thereof.

In one or more examples, 2D image data 204 is streamed from storage 210 to image viewer 212 as streamed 2D image data 216.

Image viewer 212 is a software application (e.g., a local software application or a browser based software application, without limitation) that obtains and presents information about 2D images received via streamed 2D image data 216 as a sequence of images or video. In one or more examples, image viewer 212 may be executed at display system 104.

Image viewer 212 enables a user to view 2D images that are based on streamed 2D image data 216. In some examples, image viewer 212 may optionally enable a user to browse 2D images stored at storage 210 via browsing information about the same e.g., sent with streamed 2D image data 216 or accessible via networking protocols (e.g., to view a file directory of a networked storage device, without limitation). In one or more examples, image viewer 212 includes basic features for editing a 2D image (e.g., cropping, resizing, adjusting brightness and contrast, adding text or annotations, adding designs, without limitation). Additionally or alternatively, in one or more examples, image viewer 212 includes advanced features for editing a 2D image (e.g., batch processing, color correction, image enhancement, without limitation). In one or more examples, a user may, via display system 104, image viewer 212, and supported features of image viewer 212, edit 2D images and more specifically, edit or generate new 2D image data 204 that represents an edited 2D image.

In a browser-based implementation, image viewer 212 and user interface 214 may be part of a “thin client” software application. The thin client relies on image rendering and processing by a management agent (discussed below) respectively executed at the X-ray screening system 102, a computer, or in the cloud, and so compute resources at display system 104 are not a limiting factor. In one or more examples, display system 104 may be a table computer or a smart phone running a mobile operating system, a laptop computer, desktop computer, or terminal that runs an operating system that relies primarily on web applications, or a laptop computer or desktop computer that runs a more robust operating system that can executes system and user applications locally or as web applications.

User interface 214 is a text-based, graphical-based, or combination thereof, user interface that enables a user to interact with image viewer 212 as a non-limiting example, to edit or manipulate a 2D image. In a case where image viewer 212 is a browser-based application, user interface 214 may be programmed in the Hypertext Markup Language (HTML) and data (e.g., 2D image data 204, without limitation) transferred using a web service such as the REST API or gRPC. Alternate designs may use an application programmed in C++, JAVA or Python, together with a data transfer method such as REST, gRPC, or network sockets.

The User Interface may be customized independently of the displayed images to support a specific display format (e.g., a desktop or a mobile device), workflow, or to realize a common look and feel to other applications. This contrasts with remote desktop applications, which replicate both the User Interface and the displayed images and provide limited options for customization.

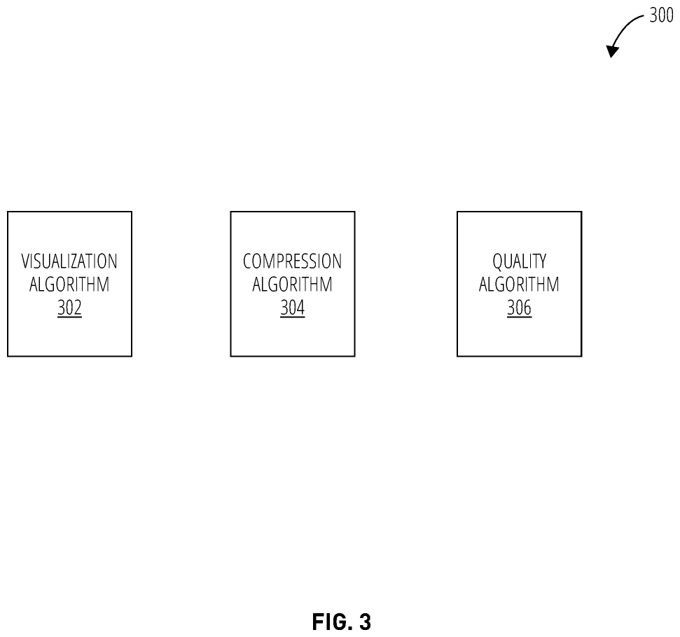

FIG. 3 is a block diagram of an image renderer 300 in accordance with one or more examples. Image renderer 300 is a non-limiting example of an image renderer(s) 206 of FIG. 2.

Image renderer 300 includes a visualization algorithm 302, a compression algorithm 304, and a quality algorithm 306.

Visualization algorithm 302 is set of rules and procedures utilized to generate a visual representation of a 3D scene based on 3D image data (e.g., streamed 3D image data 208), to generate a visual representation of 2D scene based on 2D image data (e.g., 2D image data 204), and to convert between the two. Visualization algorithm 302 may be a standard visualization algorithm or a non-standard (e.g., custom, without limitation) visualization algorithm. A non-standard visualization algorithm may be at least partially based on one or more standard visualization algorithms.

In one or more examples, a visualization algorithm is a volume rendering algorithm that models a 3D volume as a distribution of light emitting, absorbing and scattering materials. Lookup tables or mathematical equations are used to generate a transfer function that relates the 3D image values to optical properties such as color, opacity, reflectivity, and texture. Non-limiting examples of a volume rendering algorithms include:
Ray tracing: A ray tracing algorithm simulates the path of light rays as they interact with objects in a scene and calculates the color and brightness of each pixel based on the properties of the objects such as color and opacity and the position of the camera.
Rasterization: A rasterization algorithm converts the 3D image data into a set of 2D polygons or triangles, and then calculates the color and brightness of each pixel by interpolating the values of the vertices.
Volume rendering: A volume rendering algorithm is used to generate 2D images from volumetric data. A volume rendering algorithm simulates the behavior of light as it passes through a volume and calculates the color and brightness of each pixel based on the density and other properties of the volume.
Transparent projection: A transparent projection algorithm generates a 2D image of a 3D scene that includes transparent objects. Transparent objects are objects or material that allow light to pass through them, such as glass or water, or which can be modeled as transparent. A transparent projection algorithm calculates the path of light rays as they pass through the transparent objects in a scene, calculates the color and brightness of each pixel in the 2D image based on the properties of the transparent objects and the estimated position of the camera. A transparent projection algorithm may utilize any suitable mathematical model to simulate the behavior of light as it passes through different types of transparent objects or materials.
Surface rendering: A surface rendering algorithm generates a 2D image of surface of a 3D object. A surface rendering algorithm calculates the geometry and appearance of the surface of the 3D object. A surface rendering algorithm can utilize any suitable technique such as polygonal rendering, ray casting, or marching cubes.
Composite Image: Ray tracing is used to project a 3D label or mask onto the 2D image. The label is typically presented as a semi-transparent color allowing the underlying 2D image to be visualized.
Maximum Intensity Projection: In this rendering technique the maximum value encountered along a ray is used to generate the 2D image pixel value. Variations of this technique include average intensity, and the intensity at a specified position along the ray.
Cut plane: A cut plane algorithm virtually slices a 3D image based on specific angle or position. When a cut plane is applied, it creates a 2D image that shows the interior of the object or data set as if it had been sliced open. The position and orientation of the cut plane can be adjusted to show different cross-sections of the object or data set, allowing users to visualize and analyze internal structures and relationships. Cut planes may be in the axial, sagittal, coronal, or oblique orientations.

Compression algorithm 304 applies lossless compression techniques to 2D image data 204 to generate a reduced 2D image data from which the original 2D image data 204 may be recovered. Reduced 2D image data saves memory, reduces latency over a network connection, and utilizes less bandwidth over a network connection. Non-limiting examples of compression algorithm 304 include JPEGLS, MPEG encoding and similar types of algorithms.

Quality algorithm 306 applies to increase or reduce data rates in situations as a function of network performance. In cases where the network connection is temporarily unable to sustain the required image transfer speed, for example, a reduced quality version of 2D image data 204 may reduce data rates by lowers the image update or increasing the compression ratio 304.

FIG. 3 depicts an example of a single image render according to one or more examples. Image renderer(s) 206 may include multiple instances of image renders that are the same or different (e.g., having different collection of visualization algorithms, compression algorithms, or quality algorithms, without limitation) than each other.

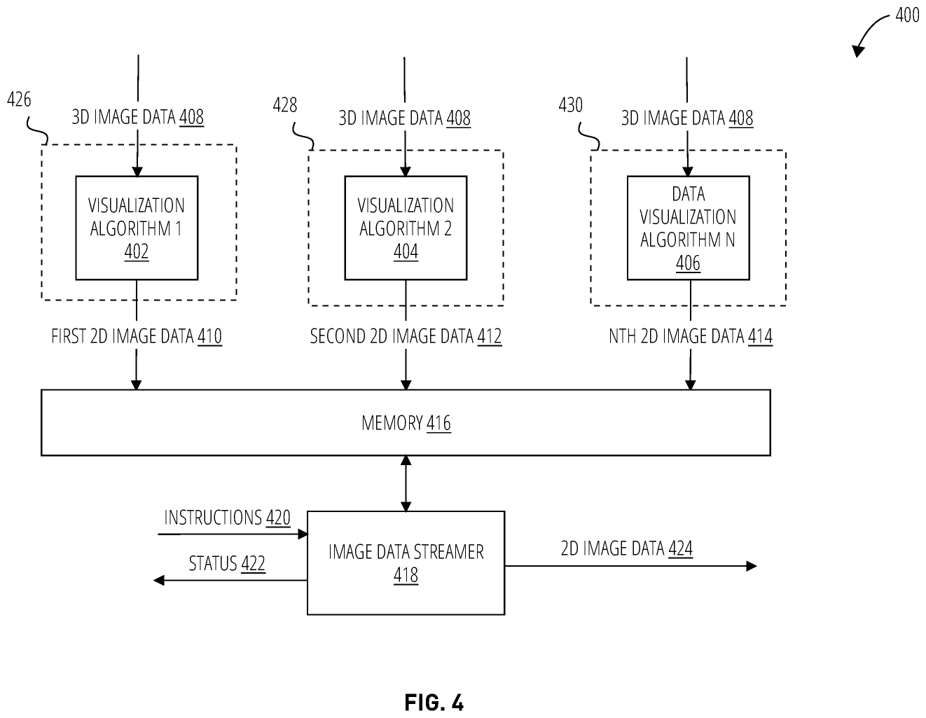

FIG. 4 is a block diagram depicting a system 400 for rendering images for display-based review, in accordance with one or more examples. System 400 is a non-limiting example of image renderer(s) 206 of FIG. 2.

System 400 includes multiple image renderers, including first image renderer 426, second image renderer 428 to the nth image renderer 430. Respective ones of the multiple image renderers implement different data visualization algorithms to convert 3D image data 408 to different forms of 2D image data. First image renderer 426 implements visualization algorithm 1 402, second image renderer 428 implements visualization algorithm 2 404 and nth image renderer 430 implements data visualization algorithm n 406.

In one or more examples, any suitable number of image renderers and visualization algorithms may be utilized. As a non-limiting example, the number of image renderers may be a function of the number of data sources, the number of display systems, the average number of visualizations per display, or the average time to review a scan.

First 2D image data 410, second 2D image data 412, and Nth 2D image data 414 generated by visualization algorithm 1 402, visualization algorithm 2 404 and data visualization algorithm n 406, respectively are stored on memory 416.

In one or more examples, image renderers may be added or subtracted in real-time, for example, as discussed below.

Image data streamer 418 streams 2D image data 424 to display system 104 or image viewer 212 more specifically, via network connection 108. Streaming 2D image data involves sending 2D image data as a sequence of independent images or as a video stream. Standard 2D image formats such as PNG, JPEG, JPEGLS, or DICOS may be used. Alternatively, video file formats such as MPEG-4, MPEG-DASH, LL-HLS may be deployed.

In one or more examples, image data streamer 418 may stream 2D image data 424 at least partially based on instructions 420 that it receives from an external source, such as an operator of display system 104 or user interface 214 or a management agent 106 or management agent 518 (described later). Image data streamer 418 may also generate, store and provide information about its status or the status of 2D image data (status 422).

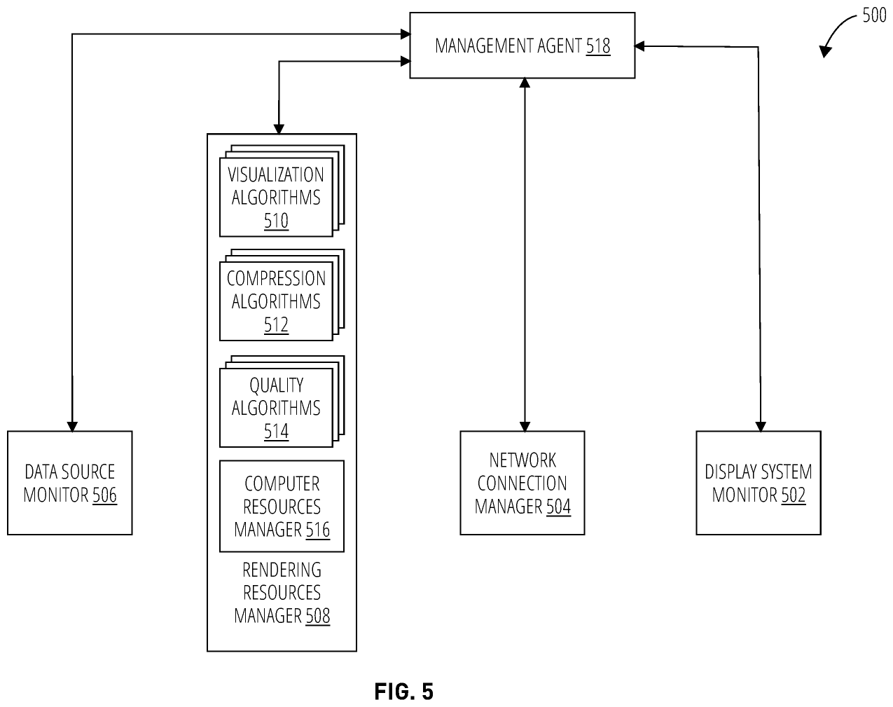

FIG. 5 is a block diagram depicting a system 500 to manage display-based review of images, in accordance with one or more examples.

System 500 includes. a display system monitor 502, a management agent 518, a rendering resources manager 508, a network connection manager 504, and a data source monitor 506. Rendering resources manager 508 includes a visualization algorithms 510, a compression algorithms 512, a quality algorithms 514, and a computer resources manager 516.

Generally speaking, the management agent 518 receives information from one or more monitors, and generates instructions at least partially based on the received information. In the specific non-limiting example depicted by FIG. 5, management agent 518 receives information from data source monitor 506, display system monitor 502, and network connection manager 504, as discussed below. In the specific non-limiting example depicted by FIG. 5, management agent 518 determines instructions for network connection manager 504 or rendering resources manager 508 as discussed below.

In one or more examples, display system monitor 502 and data source monitor 506 may be respective software applications on a shared computing device or a dedicated computing device for monitoring. In one or more examples, display system monitor 502 and data source monitor 506 may execute within the same layer(s) of the technology stack as the respective services they monitor. Additionally or alternatively, in one or more examples, display system monitor 502 and data source monitor 506 may execute at a higher layer(s) in the technology stack as the respective services they monitor and may observe inflows and outflows of data and data traces generated about operation of the services.

In one or more examples, display system monitor 502 obtains information about a display system 104, without limitation, and provides the information to management agent 518. Obtained information may include, as non-limiting examples: the number of active display systems, the rate at which 3D data is being produced, the rate that images are being reviewed, and the state of each displayed image.

In one or more examples, data source monitor 506 obtains information about the data source 3D image data, such as data source 202 of FIG. 2, without limitation, and provides the information to management agent 518. Obtained information may include, as non-limiting examples: the number of active data sources, the number of 3D data files being produced, the rate at which 3D data files are being produced, and the state of each 3D data file.

In one or more examples, rendering resources manager 508 obtains information about various image rendering processes and provides the information to management agent 518. Obtained information may include, as non-limiting examples: the number of active algorithms, the available resources, and the current state of the rendering system. Further, rendering resources manager 508 manages setup and takedown of various image renderers, such as image renderer(s) 206 of FIG. 2, without limitation. Rendering resources manager 508 has access to various rendering resources such as visualization algorithms 510, compression algorithms 512, and quality algorithms 514. Further, rendering resources manager 508 has access, indirectly, to hardware compute resources (e.g., CPUs, processing cores, random-access memory, storage devices and memory therefore, without limitation) via computer resources manager 516.

In one or more examples, computer resources manager 516 may be or include a virtualization platform to set up virtual machines to execute respective rendering processes. A respective rendering process may include one or more of: a respective visualization algorithm, a respective compression algorithm, or a respective quality algorithm—as indicated in instructions sent by management agent 518. A respective virtual machine may have hardware compute resources as indicated in instructions received from management agent 518. In one or more examples, computer resources manager 516 may add or subtract hardware resources from a virtual machine as indicated in instructions received from management agent 518.

In one or more examples, network connection manager 504 obtains information about one or more network connections, such as network connection(s) 108 of FIG. 1, without limitation, and provides the information to management agent 518. Obtained information may include, as non-limiting examples: the number (e.g., a count, without limitation) of network connections, respective identifiers of the network connections, respective states of the network connections, respective metrics of the network connections (e.g., throughput, bandwidth, data rate, without limitation), and combinations or subcombinations thereof.

In or more examples management agent 518 processes the information received from display system monitor 502, network connection manager 504, data source monitor 506, and rendering resources manager 508 to determine states of the various monitored systems and devices, determines one or more instructions at least partially based on determined states, and provides the determined instructions to one or more managers as described below.

Table 1, below, is a state table for the Management Agent Subsystem:

| | Subsystem | | | |
|---|---|---|---|---|
| | Data | | | Display |
| | Source | Rendering | Network | System |
| State | Monitor | Resource | Connection | Monitor |
| Initialize | Connect to | Connect to | Connect to | Connect to |
| | management | management | management | management |
| | agent and | agent, | agent | agent and |
| | data | initialize | | display |
| | sources | rendering | | resources |
| | | resources | | |
| Idle | Connect or | Wait for | Test network | Connect or |
| | disconnect | rendering | connection | disconnect |
| | from | request | bandwidth | to display |
| | data sources, | | and latency | resources |
| | request | | | |
| | screening | | | |
| | services | | | |
| Screening | Check for | Render | Monitor | Notify |
| | data to | images with | network | management |
| | render, | requested | connection, | agent of |
| | request | algorithm/ | adjust quality | available |
| | match with | quality and | and | resources, |
| | rendering | compression | compression | monitor |
| | and | rate, manage | based on | display |
| | display | compute | network | system |
| | resources | resources | bandwidth | requests |
| | as required | | and | and update |
| | | | latency | rendering |
| | | | | resource |
| Shut- | Complete or | Complete or | — | Complete or |
| down | cancel data | cancel | | cancel |
| | transfer | rendering | | display |
| | sessions. | sessions, | | sessions, |
| | Disconnect | shutdown | | disconnect |
| | from | resource. | | from |
| | data sources | | | resources. |

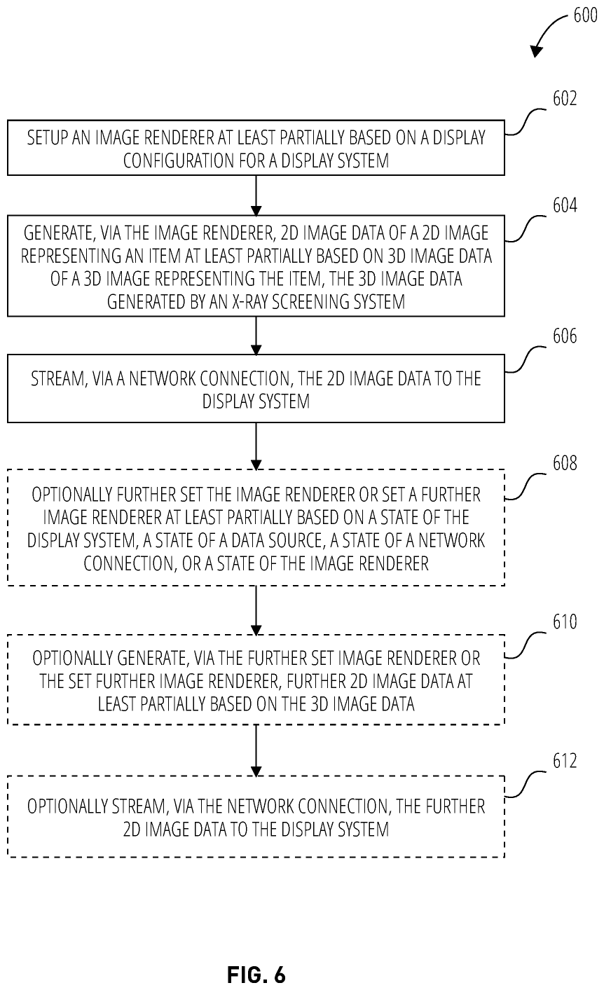

FIG. 6 is a flow diagram depicting a process 600 for display-based review of image data, in accordance with one or more examples. Some or a totality of operations of process 600 may be performed, as a non-limiting example, by system 100, system 200, image renderer 300, system 400, or system 500.

Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence.

According to one or more examples, process 600 may include setting an image renderer at least partially based on a display configuration for a display system at operation 602.

According to one or more examples, process 600 may include generating, via the image renderer, 2D image data of a 2D image representing an item at least partially based on 3D image data of a 3D image representing the item at operation 604. In one or more examples, the item may include baggage (e.g., checked, carry-on, accessible personal property, without limitation), cargo (e.g., parcels, crates, without limitation), a tray or other support device holding baggage or cargo, or combinations thereof, without limitation. In one or more examples, the 2D image or 3D image may include a segmented 2D image or 3D image, respectively, and 2D image data or 3D image data may include respective segmented image data. By way of non-limiting example, image segmentation may be performed, as non-limiting examples, by an X-ray system (e.g., a security baggage screener, image based threat detection system, or a Cloud service connected to the same, without limitation).

According to one or more examples, process 600 may include streaming, via a network connection, the 2D image data to the display system at operation 606.

According to one or more examples, process 600 optionally includes further setting the image renderer or setting a further image renderer at least partially based on a state of the display system, a state of a data source, a state of a network connection, or a state of the image renderer at operation 608. In one or more examples, information about the state of display system, data source, or network connection may be received from a third party monitor. In one or more examples, instructions to set the image renderer or set a further image renderer (which instructions may optionally include settings or desired metrics, without limitation) may be received from a management agent discussed, above.

According to one or more examples, process 600 optionally includes generating, via the further set image renderer or set further image renderer, further 2D image data at least partially based on the 3D image data at operation 610.

According to one or more examples, process 600 optionally includes streaming, via the network connection, the further 2D image data to the display system at block 612.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure include:

Example 1: A method, comprising: setting an image renderer at least partially based on a display configuration for a display system; generating, via the set image renderer, 2D image data of a 2D image representing an item at least partially based on 3D image data of a 3D image representing the item, wherein the 3D image data of the 3D image representing the item is X-ray image data; and streaming, via a network connection, the 2D image data to the display system.

Example 2: The method according to Example 1, comprising: further setting the image renderer or setting a further image renderer at least partially based on one or more of: a state of the display system, a state of a data source, a state of a network connection, or a state of the image renderer; generating, via the further set image renderer or set further image renderer, further 2D image data at least partially based on the 3D image data; and streaming, via the network connection, the further 2D image data to the display system.

Example 3: The method according to any of Examples 1 and 2, wherein the 3D image data comprises slices of a 3D volume.

Example 4: The method according to any of examples 1 through 3, comprising: streaming, via the network connection or a further network connection, image slices of a 3D volume to the image render.

Example 5: The method according to any of examples 1 through 4, wherein streaming the image slices of the 3D volume to the image renderer comprises: streaming respective image slices of the 3D volume to the image render dynamically as the respective image slices are produced by an X-ray screening system.

Example 6: The method according to any of examples 1 through 5, wherein streaming the image slices of the 3D volume to the image renderer comprises: streaming respective image slices of the 3D volume to the image render as the respective image slices become available.

Example 7: The method according to any of examples 1 through 6, wherein streaming, via the network connection, the 2D image data to the display system comprises: streaming respective 2D image data to the display system dynamically as the respective 2D image data is produced by the renderer.

Example 8: The method according to any of examples 1 through 7, comprising: responsive to a state of the network connection: changing a further 2D image data; and streaming, via the network connection, the changed 2D image data to the display system.

Example 9: The method according to any of examples 1 through 8, wherein changing the further 2D image data comprises: reducing the further 2D image data.

Example 10: The method according to any of examples 1 through 9, wherein changing the further 2D image data comprises: augmenting the further 2D image data.

Example 11: The method according to any of examples 1 through 10, wherein augmenting the further 2D image data comprises increasing a resolution associated with the 2D image data.

Example 12: The method according to any of examples 1 through 11, wherein an amount of changing the further 2D image data is at least partially based on a metric of the network connection.

Example 13: The method according to any of examples 1 through 12, setting the image renderer or a further image renderer at least partially based on a further display configuration for a further display system; generating, via the set image renderer or the set further image renderer, further 2D image data of the 2D image representing the item at least partially based on 3D image data of the 3D image representing the item, wherein the 3D image data of the 3D image representing the item is X-ray image data; and streaming, via the network connection or a further network connection, the further 2D image data to the display system.

Example 14: A system, comprising: a data source to provide 3D image data of an item generated by an X-ray screening system; one or more image renderers to generate 2D image data of an item at least partially based on 3D image data of the item provided by the data source or at least partially based on image slices taken from 3D image data of the item; an image viewer to receive a stream of 2D image data generated by the one or more image renderers and present a 2D image based on the streamed 2D image data; a network connection to carry streamed 2D image data to the image viewer; and a graphical user interface to enable a user to interact with the 2D image presented at the image viewer.

Example 15: The system according to Example 14, comprising: a management agent to: determine a state of one or more of the data source, a state of the one or more image renderers, a state of the network connection, or a state of the image viewer; and generate instructions at least partially based on determined states.

Example 16: The system according to any of Examples 14 and 15, wherein the instructions generated by the management agent comprise: an instruction to change an image metric.

Example 17: The system according to any of Examples 14 through 16, wherein the instructions generated by the management agent comprise: an instruction to change a data metric.

Example 18: The system according to any of Examples 14 through 17, comprising: one or more monitors to: obtain information about one or more of: the data source, the one or more image renderers, the network connection, or the image viewer; and provide the information to the management agent, wherein the management agent determines the states at least partially based on the information provided by the monitors.

Example 19: An apparatus comprising: at least one processor; and at least one memory to store instructions that, when executed by the at least one processor, adapt the processor to: set an image renderer at least partially based on a display configuration for a display system; generate, via the set image renderer, 2D image data of a 2D image representation of an item at least partially based on 3D image data of a 3D image representation of the item, wherein the 3D image data of the 3D image representation of the item is X-ray image data; and stream, via a network connection, the 2D image data to the display system.

Example 20: The apparatus according to Example 19, wherein the at least one memory to store instructions that, when executed by the at least one processor, adapt the at least one processor to: further set the image renderer or setting a further image renderer at least partially based on one or more of: a state of the display system, a state of a data source, a state of a network connection, or a state of the image renderer; generate, via the further set image renderer or set further image renderer, further 2D image data at least partially based on the 3D image data; and stream, via the network connection, the further 2D image data to the display system.

Example 21: The apparatus according to any of Examples 19 and 20, wherein the 3D image data comprises slices of a 3D volume.

Example 22: The apparatus according to any of Examples 19 through 21, wherein the at least one memory to store instructions that, when executed by the at least one processor, adapt the at least one processor to: stream, via the network connection or a further network connection, image slices of a 3D volume to the image render.

Example 23: The apparatus according to any of Examples 19 through 22, wherein the at least one memory to store instructions that, when executed by the at least one processor, adapt the at least one processor to: stream respective image slices of the 3D volume to the image render dynamically as the respective image slices are produced by an X-ray screening system.

Example 24: The apparatus according to any of Examples 19 through 23, wherein the at least one memory to store instructions that, when executed by the at least one processor, adapt the at least one processor to: stream respective image slices of the 3D volume to the image render as the respective image slices become available.

Example 25: The apparatus according to any of Examples 19 through 24, wherein the at least one memory to store instructions that, when executed by the at least one processor, adapt the at least one processor to: stream respective 2D image data to the display system dynamically as the respective 2D image data is produced by the renderer.

Example 26: The apparatus according to any of Examples 19 through 25, wherein the at least one memory to store instructions that, when executed by the at least one processor, adapt the at least one processor to: responsive to a state of the network connection: change a further 2D image data; and stream, via the network connection, the changed 2D image data to the display system.

Example 27: The apparatus according to any of Examples 19 through 26, wherein the at least one memory to store instructions that, when executed by the at least one processor, adapt the at least one processor to: reducing the further 2D image data.

Example 28: The apparatus according to any of Examples 19 through 27, wherein the at least one memory to store instructions that, when executed by the at least one processor, adapt the at least one processor to: augment the further 2D image data.

Example 29: The apparatus according to any of Examples 19 through 28, wherein the at least one memory to store instructions that, when executed by the at least one processor, adapt the at least one processor to: increase a resolution associated with the 2D image data.

Example 30: The apparatus according to any of Examples 19 through 29, wherein an amount of change to the further 2D image data is at least partially based on a metric of the network connection.

Example 31: The apparatus according to any of Examples 19 through 30, wherein the at least one memory to store instructions that, when executed by the at least one processor, adapt the at least one processor to: set the image renderer or a further image renderer at least partially based on a further display configuration for a further display system; generate, via the set image renderer or the set further image renderer, further 2D image data of the 2D image representation of the item at least partially based on 3D image data of the 3D image representation of the item, wherein the 3D image data of the 3D image representing the item is X-ray image data; and stream, via the network connection or a further network connection, the further 2D image data to the display system.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
setting an image renderer at least partially based on a display configuration for a display system;
generating, via the set image renderer, 2D image data of a 2D image representing an item at least partially based on 3D image data of a 3D image representing the item, wherein the 3D image data of the 3D image representing the item is X-ray image data; and
streaming, via a network connection, the 2D image data to the display system.

2. The method of claim 1, comprising:
further setting the image renderer or setting a further image renderer at least partially based on one or more of: a state of the display system, a state of a data source, a state of a network connection, or a state of the image renderer;
generating, via the further set image renderer or set further image renderer, further 2D image data at least partially based on the 3D image data; and
streaming, via the network connection, the further 2D image data to the display system.

3. The method of claim 1, wherein the 3D image data comprises slices of a 3D volume.

4. The method of claim 1, comprising:
streaming, via the network connection or a further network connection, image slices of a 3D volume to the image render.

5. The method of claim 4, wherein streaming the image slices of the 3D volume to the image renderer comprises:
streaming respective image slices of the 3D volume to the image render dynamically as the respective image slices are produced by an X-ray screening system.

6. The method of claim 4, wherein streaming the image slices of the 3D volume to the image renderer comprises:
streaming respective image slices of the 3D volume to the image render as the respective image slices become available.

7. The method of claim 1, wherein streaming, via the network connection, the 2D image data to the display system comprises:
streaming respective 2D image data to the display system dynamically as the respective 2D image data is produced by the renderer.

8. The method of claim 1, comprising:
responsive to a state of the network connection:
changing a further 2D image data; and
streaming, via the network connection, the changed 2D image data to the display system.

9. The method of claim 8, wherein changing the further 2D image data comprises:
reducing the further 2D image data.

10. The method of claim 8, wherein changing the further 2D image data comprises:
augmenting the further 2D image data.

11. The method of claim 10, wherein augmenting the further 2D image data comprises increasing a resolution associated with the 2D image data.

12. The method of claim 8, wherein an amount of changing the further 2D image data is at least partially based on a metric of the network connection.

13. The method of claim 1,
setting the image renderer or a further image renderer at least partially based on a further display configuration for a further display system;
generating, via the set image renderer or the set further image renderer, further 2D image data of the 2D image representing the item at least partially based on 3D image data of the 3D image representing the item, wherein the 3D image data of the 3D image representing the item is X-ray image data; and
streaming, via the network connection or a further network connection, the further 2D image data to the display system.

14. A system, comprising:
a data source to provide 3D image data of an item generated by an X-ray screening system;
one or more image renderers to generate 2D image data of an item at least partially based on 3D image data of the item provided by the data source or at least partially based on image slices taken from 3D image data of the item;
an image viewer to receive a stream of 2D image data generated by the one or more image renderers and present a 2D image based on the streamed 2D image data;
a network connection to carry streamed 2D image data to the image viewer; and
a graphical user interface to enable a user to interact with the 2D image presented at the image viewer.

15. The system of claim 14, comprising:
a management agent to:
determine a state of one or more of the data source, a state of the one or more image renderers, a state of the network connection, or a state of the image viewer; and
generate instructions at least partially based on determined states.

16. The system of claim 15, wherein the instructions generated by the management agent comprise:
an instruction to change an image metric.

17. The system of claim 15, wherein the instructions generated by the management agent comprise:
an instruction to change a data metric.

18. The system of claim 15, comprising:
one or more monitors to:
obtain information about one or more of: the data source, the one or more image renderers, the network connection, or the image viewer; and
provide the information to the management agent,
wherein the management agent determines the states at least partially based on the information provided by the monitors.

19. An apparatus comprising:
at least one processor; and
at least one memory to store instructions that, when executed by the at least one processor, adapt the processor to:
set an image renderer at least partially based on a display configuration for a display system;
generate, via the set image renderer, 2D image data of a 2D image representation of an item at least partially based on 3D image data of a 3D image representation of the item, wherein the 3D image data of the 3D image representation of the item is X-ray image data; and
stream, via a network connection, the 2D image data to the display system.

20. The apparatus of claim 19, wherein the at least one memory to store instructions that, when executed by the at least one processor, adapt the at least one processor to:
further set the image renderer or setting a further image renderer at least partially based on one or more of: a state of the display system, a state of a data source, a state of a network connection, or a state of the image renderer;
generate, via the further set image renderer or set further image renderer, further 2D image data at least partially based on the 3D image data; and
stream, via the network connection, the further 2D image data to the display system.

21. The apparatus of claim 19, wherein the 3D image data comprises slices of a 3D volume.

22. The apparatus of claim 19, wherein the at least one memory to store instructions that, when executed by the at least one processor, adapt the at least one processor to:
stream, via the network connection or a further network connection, image slices of a 3D volume to the image render.

23. The apparatus of claim 22, wherein the at least one memory to store instructions that, when executed by the at least one processor, adapt the at least one processor to:
stream respective image slices of the 3D volume to the image render dynamically as the respective image slices are produced by an X-ray screening system.

24. The apparatus of claim 22, wherein the at least one memory to store instructions that, when executed by the at least one processor, adapt the at least one processor to:
stream respective image slices of the 3D volume to the image render as the respective image slices become available.

25. The apparatus of claim 19, wherein the at least one memory to store instructions that, when executed by the at least one processor, adapt the at least one processor to:
stream respective 2D image data to the display system dynamically as the respective 2D image data is produced by the renderer.

26. The apparatus of claim 19, wherein the at least one memory to store instructions that, when executed by the at least one processor, adapt the at least one processor to:
responsive to a state of the network connection:
change a further 2D image data; and
stream, via the network connection, the changed 2D image data to the display system.

27. The apparatus of claim 26, wherein the at least one memory to store instructions that, when executed by the at least one processor, adapt the at least one processor to:
reducing the further 2D image data.

28. The apparatus of claim 26, wherein the at least one memory to store instructions that, when executed by the at least one processor, adapt the at least one processor to:
augment the further 2D image data.

29. The apparatus of claim 26, wherein the at least one memory to store instructions that, when executed by the at least one processor, adapt the at least one processor to:
increase a resolution associated with the 2D image data.

30. The apparatus of claim 26, wherein an amount of change to the further 2D image data is at least partially based on a metric of the network connection.

31. The apparatus of claim 19, wherein the at least one memory to store instructions that, when executed by the at least one processor, adapt the at least one processor to:
set the image renderer or a further image renderer at least partially based on a further display configuration for a further display system;
generate, via the set image renderer or the set further image renderer, further 2D image data of the 2D image representation of the item at least partially based on 3D image data of the 3D image representation of the item, wherein the 3D image data of the 3D image representing the item is X-ray image data; and
stream, via the network connection or a further network connection, the further 2D image data to the display system.
